(19) United States
(12) Patent Application Publication
(10) Pub. No.: US 2003/0089683 A1
(43) Pub. Date: May 15, 2003

(54) Circuit breaker

(76) Inventors: Per-Olof Thuresson, Grangesberg (SE); Lars Hermansson, Vasteras (SE); Thomas Roininen, Saxdalen (SE); Stefan Valdemarsson, Vasteras (SE); Stig Norstrom, Ludvika (SE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/182,896

(22) PCT Filed: Feb. 5, 2001
(86) PCT No.: PCT/SE01/00213

(30) Foreign Application Priority Data
Feb. 3, 2000 (SE) 0000346-7

(51) Int. Cl. H01H 33/02

(52) U.S. Cl. 218/154

(57) ABSTRACT

The invention relates to an electric circuit breaker that includes at least one mobile contact. The contact is connected to operating means that includes an electric motor (6). Movement converting means (16, 17) are provided for converting rotary movement of the motor (6) to translatory movement for linear movment of the mobile contact. The object is to provide an improved movement conversion means. According to the invention, the movement conversion means includes a first body, such as a screw (17), and a second body, such as a nut (16). The threads of the screw (17) and the nut (16) co-act in engagement with each other. The invention also relates to an electric plant that is equipped with such a circuit breaker, to the use of the breaker for breaking electric current, and to a method of breaking electric current with the aid of the inventive circuit breaker.

### FIELD OF INVENTION

According to a first aspect, the present invention relates to a circuit breaker of the kind defined in the preamble of claim 1. In second, third and fourth aspects, the invention relates respectively to an electric plant equipped with such an electric circuit breaker, to the use of such an electric circuit breaker, and to a method of breaking an electric current.

Circuit breaker of this kind are used in electric plants, such as in electrical switching gear for instance, so as to enable the electric current to be broken when necessary. In addition to being capable of breaking and making normal load currents, a circuit breaker shall, primarily, be able to break very quickly those short-circuiting currents that arise when a fault occurs in the system. The main components of a circuit breaker are its breaker chamber and its operating element. The circuit is opened and closed through the medium of two electric contacts located in the breaker chamber, of which contacts one is normally stationary and the other movable. The movable contact is brought into or out of contact with the stationary contact by means of the operating element. The present invention provides primarily an improvement to the operating element. The actual circuit breaking function, i.e. the design of the circuit breaker chamber, may vary. For example, the function may be a vacuum switch function, an SF₆-switch function, or an oil minimum switch function. The inventive circuit breaker is primarily intended for use with intermediate voltages and high voltages, i.e. voltages ranging from about 1 kV up to several hundreds kV.

### BACKGROUND OF THE INVENTION

The operating element of an electric circuit breaker typically includes circuit making and breaking springs in which sufficient energy for breaking and closing a circuit is stored. The operating element can either be triggered automatically or manually. The circuit closing spring functions to close the circuit breaker and to tension the circuit opening or cut-out spring. The cut-out spring comes into effect when the circuit is broken. The circuit closing spring is tensioned by an electric motor.

A spring operated circuit breaker, however, has a number of drawbacks. Movement of the mobile contact is not fully determined by the characteristics of the springs and the movement transfer mechanism. The movement pattern of the mobile contact cannot be changed by the user, since the pattern is pre-determined by the construction of the arrangement. Consequently, when the circuit closing spring or the circuit opening spring is released, the mobile contact will follow a pre-determined movement profile. Moreover, the amount of energy delivered to the mobile contact by the operating element in conjunction with breaker operating movement will be determined once and for all. It is therefore not possible to adapt movement of the mobile contact to the type of opening or closing pattern that is required in each individual case. Neither is it possible to control the speed or the acceleration of this movement.

Spring operated devices also have inherently poor precision, due to the relatively large number of components from which such devices are comprised. Because of this large number of components, it is also necessary to adjust the operating element initially, which is a complicated task and therewith time consuming. The poor precision in respect of the positioning of the mobile contact and the inability to control the movement of said contact also means that it may be necessary to include damping means at the points at which the circuit opening sequence or circuit closing sequence ends, in order to avoid uncontrolled mechanical impacts. Another drawback is that a spring operated device is very noisy in operation. This can make it necessary to sound-proof the operating element housing. Because of the large number of components of a spring operated device, it is also necessary to service the device regularly in order to maintain the function of the device and to compensate for variations in the mobile contact caused by wear and age. Finally, a spring operated device has a relatively long time delay from the moment at which an operating command is issued to the moment at which the mobile contact begins to move.

It is also known to construct hydraulic operating devices, where movement of the mobile contact is effected hydraulically. An hydraulic operating device is able to eliminate a number of those drawbacks that are associated with a spring operated circuit breaker. However, an hydraulic operating device has other drawbacks, resulting from the presence of hydraulic fluid. The viscosity of the fluid is often temperature dependent, which influences the function of the device and its movement profile. Another drawback resides in the risk of leakage of hydraulic fluid to the surroundings. The problems of high sound levels and the need for regular service are also found in the case of an hydraulically operated circuit breaker.

Electro-magnetically operated circuit breakers are also known to the art. In the case of electromagnetic operating devices, the contact operating power is either in the form of Lorentz-force or in the form of mutually co-acting magnetic fields generated by electromagnets. The Lorentz-force is that force which acts on a current carrying conductor when the conductor is placed in a magnetic field. The principle is applied, for instance, in loudspeaker coils and it is known to apply the principle in a circuit breaker operating device, e.g. in a vacuum circuit breaker. One such loudspeaker coil is described in PCT/US96/07114. A serious drawback with this type of circuit breaker, however, is that the length of stroke is relatively small. Its use for operating a circuit breaker is therefore restricted to breakers that have short lengths of stroke.

A magnetic operating arrangement utilises several electromagnets for operating or manoeuvring the mobile contact of a circuit breaker. The working principle of this device involves movement of an electromagnet connected to the mobile contact between two end positions, therewith closing or widening an air gap in a magnetic circuit. An example of one such device is described in PCT/SE96/01341. In this known device, the mobile contact of the circuit breaker is connected to a rotor that includes a plurality of iron armatures disposed in rotational symmetry. The rotating device is disposed in an outer, stationary iron core, which is provided with coils. When electric current is supplied to the coils, the rotor rotates between two end positions in which the electromagnetic pole surfaces of the armature come into contact with the pole surfaces of the iron core. As the rotor rotates, an arm on each armature moves into each coil, so as either to close or to enlarge an air gap between the pole surfaces. The air gap must be large, in order to obtain a sufficiently large length of stroke. Because a large air gap leads to high magnetic energy, a large amount of energy is required to drive the electromagnetic operating device. Furthermore, because a large air gap shall be magnetised, the time delay will be great. The length of stroke is limited, similarly to the circuit breaker operating devices that include a loudspeaker coil.

The energy delivered by an operating element to the mobile contact corresponds to the operating force multiplied by the length of stroke, or, in the case of rotary operation or manoeuvring, the torque multiplied by the angular movement. In the case of known electromagnetic operating devices, the length of stroke or the circular movement is pre-limited, since the movement has end positions. Consequently, the force generated with each movement must be very high, in order to deliver sufficient energy to the mobile contact. As a result, known electromagnetic operating devices are relatively large, clumsy and expensive. This applies primarily when high energies are required for movement of the mobile contact, as is the case when the circuit breaker is used for high voltages.

Finally, it is known to construct a circuit breaker that is operated by means of a rotary electric motor. Such circuit breakers are described, for instance, in U.S. Pat. No. 4,913,380, EP 772 214 and WO 99/60 591 for example.

U.S. Pat. No. 4,912,380 describes a circuit breaker that is operated by an electric motor. Movement of the motor shaft is geared down with a worm gear having an output shaft connected to the movable contact of the breaker via a torque limiter. The actual circuit breaking movement is not described in detail, but is apparently a rotational movement of 105°.

EP 772 214 describes a circuit breaker which is operated by a variable-speed control DC-motor. The circuit breaking movement of the movable contact is a translatory movement. Translation of the rotary movement of the motor to said translatory movement is effected with a lever transmission.

WO 99/60 591 also describes a circuit breaker where the movement of the movable contact is a translatory movement and where the breaker is driven by an electric rotary motor. The rotational movement is converted to a translatory or linear movement through the medium of a movement translating mechanism. In one case, this mechanism is comprised of a gear wheel for down changing, and a crank which is fixedly connected to the driven gear wheel. In another embodiment, a gear wheel on the motor shaft co-acts with a rack integrated with the operating rod.

DE 32 24 265 describes a circuit breaker in which movement transmission is effected through the medium of a screw-nut mechanism. However, unless special measures are taken it is not believed that a mechanism of the kind described in this prior publication would be able to generate sufficient speed in respect of the translatory movement of the movable contact. Moreover, the screw in said mechanism is also active as a movable contact part, which restricts application options.

### SUMMARY OF THE INVENTION

A circuit breaker that includes translational movement of the mobile contact and which is driven by a rotary electric motor affords significant advantages in relation to conventional circuit breakers. A large number of the drawbacks associated with conventional circuit breakers and discussed above can be eliminated. A central constructional aspect of a circuit breaker that is driven by an electric motor resides in the conversion from a rotary movement of the motor to the translatory or linear movement of the mobile contact. It is important to achieve a high speed translatory movement in order to break the circuit quickly. This conversion should take place with the smallest possible losses. Furthermore, the conversion should take place with a high degree of reliability and precision, so that the movement profile of the mobile contact will reflect to the highest possible extent the movement profile that it is intended to obtain with a given movement pattern of the electric motor.

Seen against this background, the object of the present invention is to provide a circuit breaker which is driven by an electric motor and which includes translatory movement of the mobile contact, such that conversion of the movement is achieved in an optimal manner with respect to satisfying the aforesaid desiderata, primarily with respect to achieving rapid operation of the circuit breaker.

This object has been achieved in accordance with the invention with a circuit breaker of the kind defined in the preamble of claim 1 that has the special features set forth in the characterising clause of said claim.

Because the conversion of said movement is effected with the aid of two bodies that co-act mutually through the medium of screw threads, i.e. in accordance with the screw/nut principle, the rotary movement of the one body can be converted to a linear or translatory movement of the other body in a simple fashion. Such a movement conversion mechanism can be constructed so as to obtain only small friction losses. Moreover, it can be constructed in a space-saving manner and integrated partially with the rotor of the motor and/or the mobile contact actuating device. A high speed can be achieved with respect to movement of the mobile contact, by appropriate choice of thread pitch or lead. The mechanism is also relatively well protected from external forces. Together with the simple construction of the mechanism, this results in very high functional security. Good precision is obtained with regard to the movement profile of the translatory movement in relation to the rotational movement, which provides a good possibility of controlling and adjusting the translatory movement. The simplicity of the device and its reliability in operation enables the device to be manufactured and maintained at low costs.

Because the thread of the screw has several starts, a sufficiently large pitch or lead can be obtained to enable rapid tripping of the breaker to be achieved without overloading the thread flanks. This is accomplished because the axial thrust is distributed over several threads.

According to one preferred embodiment of the invention, the first body is a screw and the second body is a nut. This is believed to be the most practical embodiment for implementing the construction of the movement converting device.

In some cases it may be beneficial for the nut to be non-rotatably connected to the rotor of the electric motor and to non-rotatably connect the screw to the mobile contact. This will conveniently enable the electric motor and the mobile contact to be integrated with respective bodies. In this regard, the nut may be fully integrated with the rotor, so that the rotor per se forms the nut. This contributes towards reducing the axial length of the operating device.

However, it may be beneficial from certain aspects for the screw to be non-rotatably connected to the rotor of the electric motor and the nut to be the mobile contact. The fact that the nut will therewith carry out the translatory movement and the nut the rotary movement enables the torque to be minimised. This contributes towards minimising the size of the electric motor and the size of the current source. These two alternatives therefore constitute preferred alternative embodiments of the invention.

The screw and the nut of an inventive movement translating mechanism will normally be encapsulated and therefore not-readily accessible for service during the lifetime of the device. It is therefore important that the screw threads are such as to be able to co-act with each other with low friction despite the absence of maintenance possibilities.

According to one preferred embodiment of the invention, the nut is a ball nut. This enables the friction losses in the movement translating device to be kept low without requiring external lubrication.

In one alternative embodiment, the screw threads of at least one body is coated with a friction reducing and/or wear reducing material. It is possible to reduce friction losses and wear in a manner that will eliminate the requirement of maintenance without complicating the mechanism. The coating will preferably comprise a slip varnish, for instance molykote® or achieved by nedox®-treatment. This will result in a very hard and durable layer or coating that will withstand high surface loads and high sliding speeds, and that is also durable with respect to wear. The anti-friction properties will come into effect immediately, in response to the rapid acceleration of the mobile circuit breaker contact. This will apply even after a long period of inactivity, at both low and high temperatures.

According to another alternative embodiment, the nut includes a lubricant-filled chamber that is open towards the flanks of the screw thread. The threads will therefore be thoroughly lubricated immediately there is any relative movement between the nut and the screw. The chamber is filled with lubricant in the manufacture of the device. The lubricant will preferably be of a kind that retains its lubricating capacity within a wide temperature range, e.g. a temperature range of −40° to +70° C.

In one preferred variant of the latter embodiment, the radial dimensions of the chamber decrease in a direction towards one or both axial ends of the chamber. For example, the sides of the chamber may slope and therewith cause the lubricant to be pressed in against the flanks of the thread of the screw in response to the rapid acceleration that occurs when the circuit breaker is tripped.

According to one preferred embodiment the lubricant is in a powder or paste form, therewith obviating the risk of lubricant leaking from the chamber.

According to one preferred embodiment of the invention, the lubricant is comprised of molybdenum disulphide particles and/or graphite. This is a suitable choice with respect to a lubricant that has the aforesaid desirable properties.

According to a further preferred embodiment, a loose plate or washer is disposed in the chamber. The plate moves in response to the acceleration forces, therewith propelling the lubricant so as to further increase the pressure on the oil. Lubrication will therewith be more effective and positive.

In order to achieve the fastest possible breaking movement, the thread pitch will preferably be large so that pronounced translatory movement will be obtained with each rotation of the motor. Accordingly, in one preferred embodiment of the invention the lead attained by the screw thread and nut thread will be at least 10 mm/revolution, preferably at least 30 mm/revolution.

According to another preferred embodiment of the invention the threads have a trapezoidal shape. The threads will be subjected to large external forces as a result of the rapid movement and pronounced acceleration forces. Trapezoidal threads enable the flanks of the threads to slope to a lesser degree, so that a relatively large portion of the contact force between the threads will be utilised for the transfer of the axially directed force.

According to another preferred embodiment of the invention the device is driven by a plurality of electric motors, therewith enhancing reliability by virtue of the fact that the circuit breaker can be operated even in the event of a malfunction of one of the motors. The motors may be arranged side-by-side and have mutually parallel shafts. Alternatively, the motors may be disposed axially in line with each other, i.e. with coincident rotary shafts. The use of several motors also promotes the possibility of a module concept where one and the same motor size can be used for circuit breakers of different sizes, by including two or more such motors when applicable.

The advantageous embodiments of the inventive circuit breaker described above are set forth in the claims dependent on claim 1.

An electric plant according to the second aspect of the invention, the use of the inventive circuit breaker according to the third aspect of the invention, and a method of breaking an electric current in accordance with the fourth aspect of the invention are set forth in respective claims 16, 17 and 18.

The inventive electric plant, the inventive use and the inventive method afford advantages that correspond to the aforementioned advantages relating to the inventive electric circuit breaker.

The invention will now be described in more detail with reference to preferred embodiments of the invention and also with reference to the accompanying drawings.

### BRIEF DESCRIPTION OF THE DRAWINGS

FIG. 1 is a schematic illustration of an electric circuit breaker.

FIG. 2 is a longitudinal sectional view of the circuit-breaker operating device according to a first embodiment of the invention.

FIG. 3 is a sectional view corresponding to the view of FIG. 2 and illustrating a second embodiment of the invention.

FIG. 4 illustrates an alternative embodiment of a part of the FIG. 3 illustration.

FIG. 5 illustrates a part of the FIG. 2 illustration.

FIG. 6 is a diagram illustrating part of an inventive switchgear.

FIG. 7 is a schematic illustration of an alternative drive means.

### DESCRIPTION OF PREFERRED EMBODIMENTS

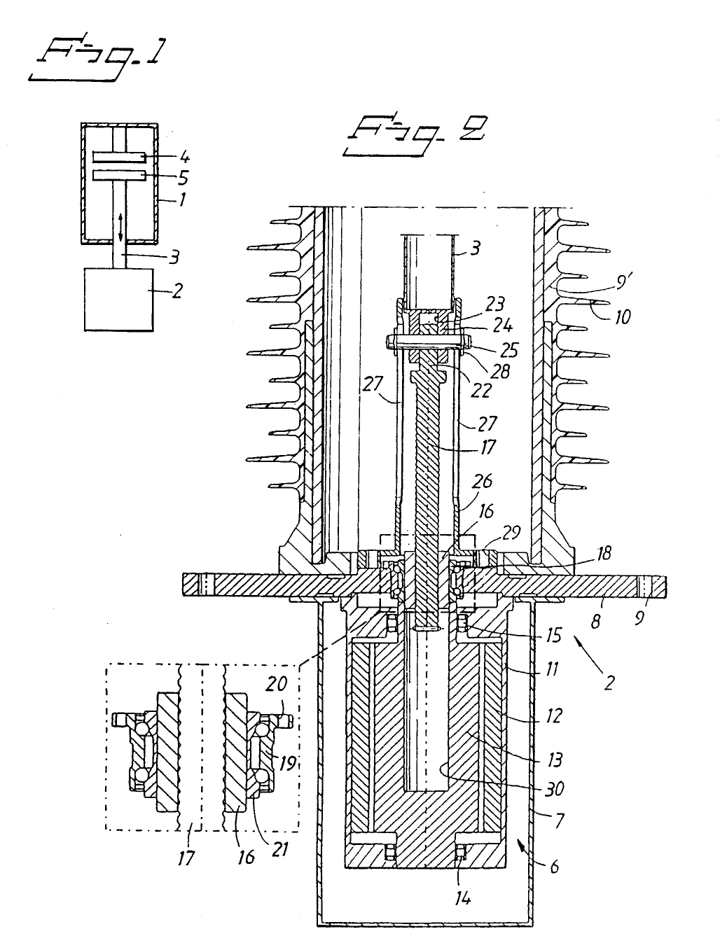

FIG. 1 illustrates schematically the principles of an electric circuit breaker, which comprises a breaker chamber 1, an operating device 2, and an operating rod 3. The breaker chamber accommodates a stationary contact 4 and a mobile contact 5. Each of the contacts is connected electrically to a respective conductor. Under normal conditions, the contacts 4, 5 lie in contact with each other and current is led from one conductor to the other conductor through the breaker. If it is necessary to break the current for some reason or other, for example as a result of a short circuiting current caused by a fault, the mobile contact 5 will be drawn away from its contact with the stationary contact 4 at a very high speed. This initially results in arcing between the contacts, wherewith the arc is extinguished shortly after the contacts having separated from each other. The circuit is re-closed by bringing the mobile contact 5 back into contact with the stationary contact 4. Initiation of breaking and closing the current can be effected manually or automatically. Opening and closing of the circuit breaker is effected through the medium of the operating rod 3, which is connected to the mobile contact and also to drive means in the breaker operating unit. This principle construction of a circuit breaker is common to various types of breaker and may, of course, have many different configurations. A large number of the components normally found in a circuit breaker have been excluded from the figure, so that the actual working principle of the breaker will be seen more clearly. The continued description relates more specifically to part 2 in FIG. 1, in other words to the operating device. The device has been illustrated as a unit which is separate from the breaker chamber, although it will be understood that these two components are built together in practice.

FIG. 2 illustrates a first embodiment of the operating device 2 of an electric circuit breaker having a principle construction of a kind similar to that described with reference to FIG. 1. The operating device 2 includes an electric motor 6 housed in a casing 7. One end of the casing is fastened to a mounting plate 8 which is carried by a stand in some suitable manner, for example with the aid of fastener bolts passing through holes 9 in the plate 8. A hollow insulating post 9′ made of porcelain for instance extends upwards in the figure, from the side of the plate distal from the motor. Flanges or fins 10 are disposed on the outside of the insulation post 9′ in order to provide an extended leakage path. The operating rod 3 is disposed inside the insulation post. The upper end (not shown) of the insulation post accommodates the circuit breaker chamber, and the mobile contact of the breaker is rigidly connected to the operating rod 3. The operating rod 3, the insulation post 9 and the motor 6 are all coaxial with one another.

A movement translating mechanism is provided for converting rotary movement of the rotor 13 of said motor to translatory movement of the operating rod 3, for breaking or closing the circuit breaker in accordance with that described above with reference to FIG. 1. The movement translating mechanism will be described in more detail further on.

Each end of the rotor 13 of the motor is mounted in the motor housing 11 by means of a respective bearing 14 and 15. The stator 12 of the motor is fixed to the motor housing 11 and the motor housing is fixed to the plate 8. The rotor 13 has a centric axial bore 30 which extends along the larger part of the length of the rotor. The plate 8 has an opening which is coaxial with the motor shaft and in which a nut 16 is mounted for rotation in a double-acting angular contact ball bearing 18. The outer ring 19 of the bearing 18 is fastened to the plate 8 by bolts (not shown) disposed in bores 20 through a flange on the outer ring. The inner ring 21 of the bearing 18 is non-rotatably connected to the nut 16. The inner ring 21 is also non-rotatably connected to the rotor 13.

A screw 17, that is to say a threaded rod, extends through the nut. The threads of the nut 16 and the screw 17 co-act in engagement with each other. Relative rotation between the nut and the screw will thus cause the screw to be moved axially relative to the nut. The end of the screw 17 distal from the motor, i.e. the upper end of the screw in the figure, is connected to the operating rod 3 of the circuit breaker, by virtue of the other end of the screw extending into a bore 23 in the lower end 24 of the operating rod 3. The connection is secured by a diametrically disposed pin 25 that extends through the ends of the screw and operating rod.

A guide sleeve 26 surrounding the screw 17 extends from the plate 8. The guide sleeve is provided with diametrically opposed, axially extending guide slots or tracks 27. The pin 25 extends through each guide track 27 and is provided with a lock washer 28 at each end. The width of the guide track 27 coincides with the diameter of the pin 25. The screw 17 is therewith non-rotatably connected to the guide sleeve 26. In turn, rotation of the guide sleeve 26 is prevented by virtue of the sleeve being secured to the plate 8 by means of bolts (not shown) fitted through the bores 29. The inner diameter of the guide sleeve 26 is adapted so as to enable the operating rod 3 to be pushed thereinto with a small clearance.

Thus, because the nut 16 is fixed axially as a result of the nut mounting and because the screw 17 is fixed against rotation by means of the aforedescribed arrangement, rotary movement of the nut will cause the screw to be moved in the direction of its long axis.

FIG. 2 illustrates the breaker operating part when the breaker is in its normal state, i.e. when closed.

When the breaker shall be activated to break the current, the motor 6 is started so that its rotor 13 turns in a clockwise direction as seen from the top of the figure. This forces the screw to be displaced downwards and therewith move the mobile contact 5 (see FIG. 1) out of contact with the fixed contact. The length of the centric bore 30 is sufficient to enable the screw to be moved through the distance required to finalise breaking of the current. The lower part of the operating rod 3 will slide down into the guide sleeve 26, during this current breaking process.

The motor is stopped when breaking of the current is complete, wherewith the bottom end of the screw 17 will be located close to the bottom of the bore 30. The pin 26 will then be situated at the lower end of respective guide tracks 27. When later re-setting the circuit breaker, the motor is started and rotates in the opposite direction, wherewith the screw 17, and therewith the operating rod, is moved up until the mobile contact 5 is again in contact with the stationary contact, wherewith the components are again located in the position shown in FIG. 2.

It is essential that the circuit breaking process takes place very quickly. It is therefore desirable that the motor has a high speed of rotation and a large transmission with respect to conversion to translatory movement. The screw therefore has a large thread pitch, as will be evident from FIG. 2. Moreover, large acceleration and deceleration forces are also achieved. It is therefore important that the components subjected to inertia forces have the smallest possible mass. This is why the operating rod 3 is hollow.

As will be seen from the figure, the thread on the screw has several starts. This enables the threads to be given a large pitch without overloading the threads. With a lead s=3 mm/revolution a translatory movement of the breaker of 3 mm would be obtained with each revolution of the motor. With eight starts and a correspondingly large lead (pitch) the translatory movement will be 24 mm/revolution and will be 36 mm/revolution in the case of twelve starts. Consequently, twelve starts require 3.33 revolutions of the motor to obtain breaker movement with a stroke length of 120 mm.

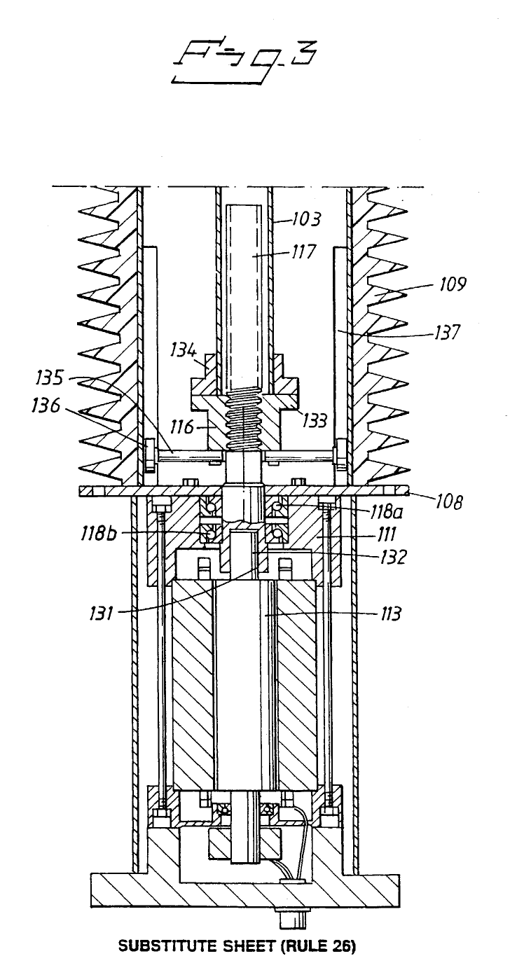

FIG. 3 illustrates an alternative embodiment of the movement translating mechanism. The greatest difference between the embodiment shown in FIG. 2 and the embodiment shown in FIG. 3 is that the nut of the FIG. 2 embodiment rotates and movement of the screw is translatory, whereas in the FIG. 3 embodiment the screw rotates and movement of the nut is translatory. In this latter case, the screw 117 is non-rotatably connected to the upper trunnion 132 of the rotor 113. The lower end of the screw is provided to this end with a centric axial bore 131 whose diameter corresponds to the diameter of the rotor shaft. The trunnion 132 is inserted into the bore 131 and secured against rotation by means of a cotter or like pin.

The motor is also mounted on one side of an attachment plate 108 in this embodiment, and an insulation post 109 that accommodates an operating rod 103 and a breaker chamber extends from the opposite side of the plate. The screw 117 is mounted in two angular contact ball bearings 118a, 118b disposed in the motor housing 111. The screw is therewith fixed axially. Thus, the screw 117 is arranged for rotation with the rotor 113 of the motor but is immovable in its axial direction.

A nut 116 co-acts with the thread on the screw 117. The nut 116 is non-rotatably connected to the operating rod 103 with the aid of attachment flanges 133, 134 on the nut and the operating rod respectively. The operating rod 103 is hollow and has an inner diameter sufficient to provide room for the screw 117.

The nut 116 also includes a device that prevents the nut from rotating. This device comprises two arms 135 each of which has a wheel 136 mounted at one end thereof. An axially extending track 137 is provided in the same radial position as respective wheels 136. The track may have the form of a slotted tube. Each wheel 136 is intended to roll in respective tracks 137. This arrangement enables the nut 116 to be held firmly against rotation, while permitting the nut to move axially.

Thus, because the screw 117 is mounted so as to be immovable in an axial direction and the nut 116 is fixed against rotation by means of the described arrangement, rotary movement of the screw 117 will force the nut 116 to move axially.

FIG. 3 shows in the breaker in its opened state. The breaker is closed by rotation of the rotor 113 of the motor in one direction, so that the nut 116 is moved upwards and therewith push up the operating rod 103 to which the mobile contact is connected. Breaking of the current is effected by rotation of the rotor 113 in the opposite direction.

FIG. 4 illustrates an alternative embodiment of a part of the FIG. 3 embodiment. This alternative embodiment is thus of the kind in which the screw 117 rotates and movement of the nut 116 is translatory. The nut 116 is divided into two parts, i.e. an upper part 116a connected to the operating rod 103, and a lower part 116b. The two parts are non-rotatably connected to each other in some appropriate manner. Each part of the nut has on its inner side, i.e. the side that faces towards the other part, cut-outs or recesses 138a, 138b disposed around the centre hole. In the illustrated case, respective recesses 138a, 138b have the shape of a truncated cone with the cone apex directed away from said other part. The recesses define therebetween a chamber 139 in the two-part nut 116. The chamber 139 surrounds the screw 117 extending through the nut 116 and is filled with lubricant 140, for instance a powder or a paste that includes particles of molybdenum sulphide and/or graphite. The lubricant has the function of lubricating the threads of the screw. These threads are lubricated each time the breaker is operated, as the nut is screwed up or down along the screw, depending on whether the circuit is closed or opened.

Because of the conicity of the wall, the lubricant will be pressed out in a direction towards the apex of one cone with powerful acceleration, which can reach 500 m², so as to penetrate effectively into the threads. A loose washer or plate 141 is also disposed in the cavity 139. This washer further contributes in promoting the extrusion of lubricant 139 out to the threads.

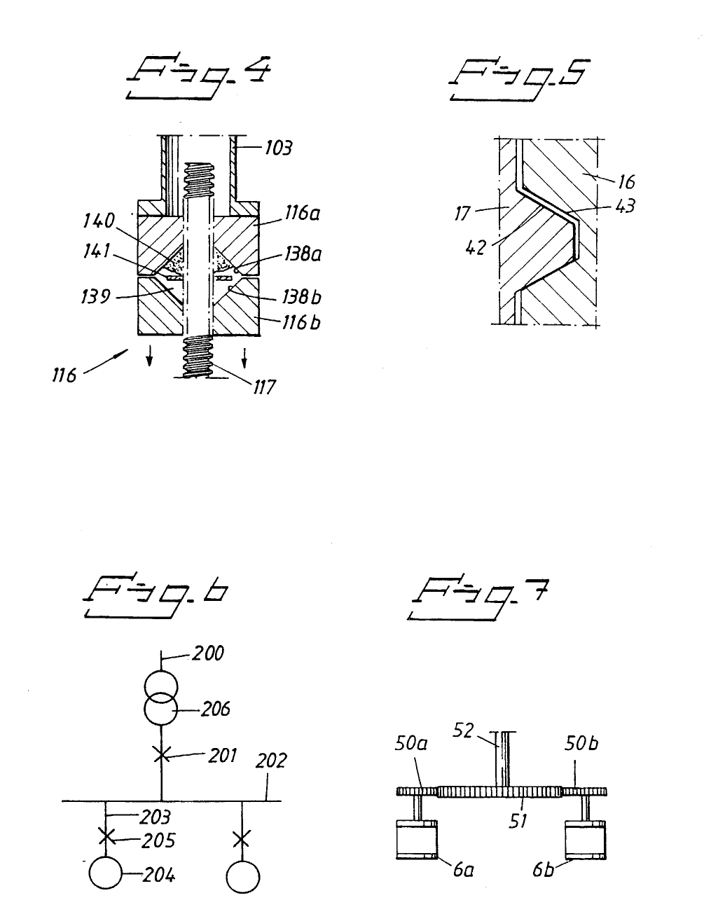

FIG. 5 is an enlarged sectional view of part of the FIG. 2 embodiment, namely of the mutually co-acting threads of the screw 17 and the nut 16. These threads are trapezoidal. The flanks 42 of the screw thread and/or the flanks 43 of the nut thread are coated with a molykote^{R} layer of about 10-20 mμ in thickness. The coefficient of friction will therewith be about 0.05.

FIG. 7 illustrates an embodiment in which two motors 6a, 6b are used to drive a circuit breaker. Each motor drives through the medium of a respective gear wheel 50a, 50b gearwheel 51 on an output shaft 52. The output shaft is connected to a movement conversion mechanism of the kind shown in FIG. 2 or in FIG. 3.

The inventive breaker can be used for both single-pole breaking and three-pole breaking. Electric current can be supplied to the motor from a condenser bank, a battery, or from an electric network.

FIG. 6 illustrates an electric plant which includes part of an electric switchgear. An input conductor 200 is connected to a collecting rail 202 via a transformer 206 and a first circuit breaker 201. Consumer lines extend from the collecting rail 202 to respective loads 204, via a respective circuit breaker 205. Each breaker 201 and 205 is constructed in accordance with the inventive breaker.

1. An electric circuit breaker that includes at least one mobile contact (5) connected to an operating device (2) which includes at least one rotary electric motor (6), wherein movement translating means (16, 17; 116, 117) are adapted to convert rotary movement of the electric motor (6) to translatory movement for moving the movable contact (5), wherein the movement translating means (16, 17; 116, 117) includes a first body (17; 117) that has a generally cylindrical outer surface provided with at least one helical thread, and a second body (16; 116) that has a generally cylindrical hole provided with at least one helical thread, wherein the thread of the first and the second bodies co-act in engagement with each other, and wherein the breaker is characterized in that the threads of respective bodies (16, 17; 116, 117) have a plurality of starts.

2. An electric circuit breaker according to claim 1, characterized in that the first body is a screw (17; 117) and the second body is a nut (16; 116) wherein the screw has a greater axial length than the nut.

3. An electric circuit breaker according to claim 2, characterized in that the nut (16) is non-rotatably connected to the rotor (13) of the electric motor, and the screw (17) is non-rotatably connected to the mobile contact (5).

4. An electric circuit breaker according to claim 2, characterized in that the screw (117) is non-rotatably connected to the rotor (113) of the electric motor and the nut (116) is non-rotatably connected to the mobile contact (5).

5. An electric circuit breaker according to any one of claims 2-4, characterized in that the nut (16; 116) is a ball nut.

6. An electric circuit breaker according to any one of claims 2-4, characterized in that the thread of at least one of said bodies (16, 17; 116, 117) is coated with a layer (42, 43) that has wear and/or friction reducing properties.

7. An electric circuit breaker according to any one of claims 2-4, characterized in that the nut (16; 1116) includes a chamber (139) that is open towards the thread flanks of the screw (117) and accommodates a lubricant.

8. An electric circuit breaker according to claim 7, characterized in that the radial dimensions of the chamber (139) decrease in a direction towards one or both axial ends of the chamber (139).

9. An electric circuit breaker according to claim 7 or 8, characterized in that the lubricant (140) is in powder or paste form.

10. An electric circuit breaker according to any one of claims 7-9, characterized in that the lubricant (140) includes molybdenum disulphide particles and/or graphite.

11. An electric circuit breaker according to any one of claims 7-10, characterized by a loose plate or washer (141) placed in the chamber (140).

12. An electric circuit breaker according to any one of claims 1-10, characterized in the lead of the thread of respective bodies (16, 17; 116, 117) corresponds to at least 10 mm/revolution, preferably 30 mm/revolution.

13. An electric circuit breaker according to any one of claims 1-12, characterized in that the threads are trapezoidal in shape.

14. An electric circuit breaker according to any one of claims 1-13, characterized in that the breaker operating means includes a plurality of rotary electric motors (6a, 6b).

15. An electric plant (200-205) comprising at least one electric circuit breaker (201, 205), characterized in at least one of the electric circuit breakers (201, 205) is of the kind defined in any one of claims 1-14.

16. The use of an electric circuit breaker according to any one of claims 1-14, for the purpose of breaking an electric current.

17. The method of breaking electric current, characterized by breaking the current with the aid of an electric circuit breaker of the kind defined in any one of claims 1-14.
